(19) United States
(12) Patent Application Publication
(10) Pub. No.: US 2012/0268822 A1
(43) Pub. Date: Oct. 25, 2012

(54) ANTIREFLECTIVE HIERARCHICAL STRUCTURES

(76) Inventors: Bee Khuan Jaslyn Law, Singapore (SG); Hong Yee Low, Singapore (SG); Ming Hua Andrew Ng, Singapore (SG); Ai Yu He, Singapore (SG)

(21) Appl. No.: 13/450,370

(22) Filed: Apr. 18, 2012

Related U.S. Application Data
(60) Provisional application No. 61/477,054, filed on Apr. 19, 2011.

(51) Int. Cl. G02B 1/11; B82Y 15/00

(52) U.S. Cl. 359/580; 977/902

(57) ABSTRACT

An antiretlective biomimetic hierarchical structure, a composite antiretlective hierarchical structure, and an antiretlective surface including a pattern of antiretlective biomimetic hierarchical structures are provided. The antiretlective hierarchical structures include one or more clusters of primary structures and a plurality of secondary structures formed on each of the primary structures. The primary structures have dimensions in the micrometer range with a major dimension of approximately two micrometers. Each of the secondary structures has dimensions in the nanometer range wherein the pitch and height are approximately three hundred nanometers.

### CROSS-REFERENCE TO RELATED APPLICATION

The present application claims priority to U.S. Patent Application No. 61/477,054, filed 19 Apr., 2011.

### FIELD OF THE INVENTION

The present invention generally relates to antireflective structures, and more particularly relates to two-part antireflective hierarchical structures.

### BACKGROUND OF THE DISCLOSURE

Anti-reflection surfaces can be used with photovoltaic to improve solar cell light collection efficiency, with light sensors and optical devices to improve performance and with displays to improve contrast, reduce glare and prevent “ghost images”. Conventional approaches to create antireflection surfaces by ordered surface structuring have used a “motheye” structure. The “motheye” structure imitates the eye structures of nocturnal insects, such as moths, which have unique antireflection property due to regular arrays of protrusions on the eye surface. “Motheye” structures have been artificially created using fabrication techniques such as interference lithography, photolithography and etching, and molding. Some companies have manufactured these structures on plastic films to create antireflection films. However, these films that utilize the “motheye” structures typically have reflectivity ˜1% in the visible wavelength range (400-800 nm) and are not easily scalable.

Thus, what is needed is an antireflective film that achieves reflectivity less than one percent and is scalable without complex fabrication. Furthermore, other desirable features and characteristics will become apparent from the subsequent detailed description and the appended claims, taken in conjunction with the accompanying drawings and this background of the disclosure.

### SUMMARY

According to the Detailed Description, an antireflective biomimetic hierarchical structure is provided. The antireflective biomimetic hierarchical structure includes one or more clusters of primary structures and a plurality of secondary structures formed on each of the primary structures. The primary structures have dimensions in the micrometer range, and the secondary structures have dimensions in the nanometer range.

In accordance with another aspect, a composite antireflective hierarchical structure is provided. The composite antireflective hierarchical structure includes a primary structure having a major dimension of approximately two micrometers and one or more secondary structures formed on the primary structure. Each of the secondary structures has dimensions of approximately three hundred nanometers in pitch and height.

In accordance with yet another aspect, an antireflective surface is provided. The antireflective surface includes a pattern of antireflective biomimetic hierarchical structures. Each of the antireflective biomimetic hierarchical structures includes a primary structure and one or more secondary structures. The primary structure has a major dimension of approximately two micrometers. The secondary structures are formed on the primary structure and each one has dimensions of approximately three hundred nanometers in pitch and height.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 illustrates a process flow diagram of a nanoimprinting process for fabrication of antireflective hierarchical structures in accordance with a present embodiment.

FIG. 2, including FIGS. 2A to 2C, illustrates antireflective hierarchical structures in accordance with the present embodiment, wherein FIG. 2A illustrates a top left front perspective of a cluster of primary structures in accordance with the present embodiment, FIG. 2B illustrates a top left front perspective of a plurality of secondary structures formed on the primary structures in accordance with the present embodiment, and FIG. 2C illustrates a cross sectional view of the composite antireflective hierarchical structures in the z-axis direction in accordance with the present embodiment.

FIG. 3, including FIGS. 3A and 3B, illustrates graphs of reflectivity of the antireflective hierarchical structures of FIG. 2 in accordance with the present embodiment as compared to conventional antireflective “motheye” structures, wherein FIG. 3A is a graph illustrating reflectivity of the antireflective hierarchical structures in accordance with the present embodiment across the visible light spectrum and FIG. 3B is a graph illustrating reflectivity of the conventional antireflective “motheye” structures across the visible light spectrum.

FIG. 4 illustrates a table of different antiretlective structures and their corresponding refractive index profile, including the antireflective hierarchical structures in accordance with the present embodiment.

FIG. 5, including FIGS. 5A to 5C, illustrates a comparison of “S” shape antireflective structures and parabolic antireflective hierarchical structures, wherein FIG. 5A illustrates a top left front perspective view of the “S” shape antireflective structures, FIG. 5B illustrates a top left front perspective view of the parabolic antireflective structures, and FIG. 5C is a graph of calculated reflectivity of the structures of FIGS. 5A and 5B and the experimentally determined reflectivity of the hierarchical structures in accordance with the present embodiment.

FIG. 6, including FIGS. 6A to 6C, illustrates measured reflectivity of the component structures and the composite structures of the antireflective hierarchical structures in accordance with the present embodiment, wherein FIG. 6A is a graph of the reflectivity of an individual primary structure of the antireflective hierarchical structures across the visible light spectrum in accordance with the present embodiment, FIG. 6B is a graph of the reflectivity of an individual secondary structure of the antireflective hierarchical structures across the visible light spectrum in accordance with the present embodiment, and FIG. 6C is a graph of the reflectivity of a composite antireflective hierarchical structure in accordance with the present embodiment across the visible light spectrum.

And FIG. 7, including FIGS. 7A to 7C, illustrates views and reflectivity of antireflective hierarchical structures including unmerged primary structures in accordance with alternate embodiments, wherein FIG. 7A is a top left front perspective view of composite antireflective hierarchical structures including unmerged primary structures with a secondary structure imprint time of three hundred seconds, FIG. 7B is a top left front perspective view of composite antireflective hierarchical structures including unmerged primary structures with a secondary structure imprint time of seven hundred and eighty seconds, and FIG. 7C is a graph of the reflectivity of the composite structures of FIGS. 7A and 7B across the visible light spectrum.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the present and alternate embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

Conventional approaches to create antireflection surfaces by ordered surface structuring have used a “motheye” structure. Scientists noticed that the eyes of nocturnal insects such as moths have unique antireflection property. The “motheye” structure was an antireflective structure that mimicked the biological structure of the eyes of these nocturnal insects. The eyes of such nocturnal insects have raised nanoprotrusions that are roughly three hundred nanometers in height and spaced in a hexagonal pattern with centers approximately three hundred nanometers apart. Thus, scientists developed biomimetic “motheye” structures consisting of regular arrays of nanoprotrusions. The “motheye” structures have been artificially created using different fabrication techniques such as interference lithography, photolithography and etching. The“motheye” structures are replicated onto plastic films to create conventional antireflection films. These films that utilize the “motheye” structures typically have reflectivity of approximately one percent across the visible wavelength range (four hundred to eight hundred nanometers).

In order to achieve reflectivity less than one percent, several additional approaches have been developed. For example, high aspect ratio “motheye” structures have been used to create a more gradual refractive index profile. The problem with such high aspect ratio structures, however, is their robustness. Additionally, shape variations to the protrusions by using “S” shaped protrusions have been developed. The disadvantage with this approach is the more complex fabrication necessary to achieve the shape through a combination of widening and etching of the protrusion. Also, direct replication from the biotemplate of a compound “fly” eye structure has been attempted. However, this approach is only in a proof-of-concept stage of development and it is limited for practical applications as replication from the biotemplate of the fly-eye is not scalable.

The present embodiment uses a novel type of antireflection structure, known as hierarchical structure, as a form of biomimetic antireflective structure for forming a composite “motheye” structure in order to achieve a better antireflection performance than the conventional “motheye” structures. The antireflective biomimetic hierarchical structures are three-dimensional structures as compared to conventional “motheye” structures (which are typically two-dimensional structures). In addition, the present embodiment uses aspect ratio variation to further create a more gradual refractive index profile to minimize the reflection as the three-dimensional structure approach allows additional variations in the z-direction. Using the structure in accordance with the present embodiment, a reflectivity of 0.16%˜0.67% (versus a reflectivity: 0.36%˜1.4% using conventional “motheye” structures) can be achieved over the visible wavelength range from four hundred to eight hundred nanometers.

Another advantage of the present embodiment is that the requirement for high aspect ratio structure is not required, making the hierarchical structures more robust and more scalable. In addition, fabrication of the antiretlective biomimetic hierarchical structures in accordance with the present embodiment is controllable, through manufacturing techniques such as sequential nanoimprintin. Nanoimprinting is a known scalable patterning technique, making the antiretlective biomimetic hierarchical structures in accordance with the present embodiment manufacturable without complex fabrication techniques.

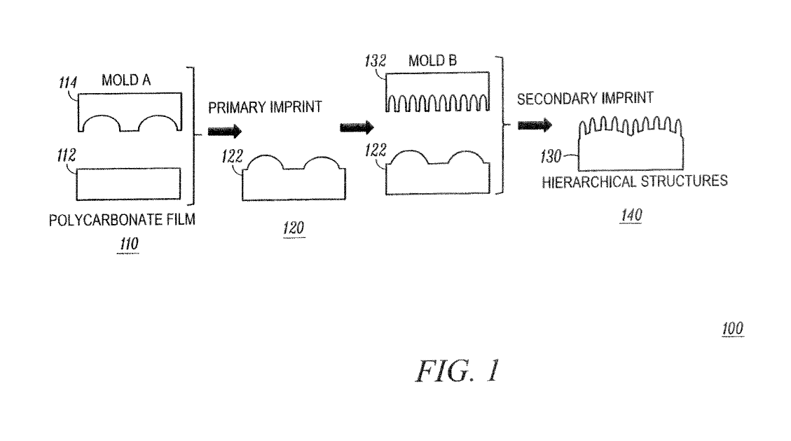

Referring to FIG. 1, a process flow diagram 100 depicts four steps 110, 120, 130, 140 of a nanoimprinting process for fabrication of antiretlective biomimetic hierarchical structures in accordance with the present embodiment. The antiretlective biomimetic hierarchical structures are fabricated onto a commercially available free-standing polycarbonate (PC) film 112 using a two step sequential nanoimprinting process 100 with specific imprint conditions. At step 110, a mold 114 for nanoimprinting primary structures is provided. The mold 114 in accordance with the present embodiment includes concave microlens structures having approximate dimensions of 1.8 μm diameter, 2 μm pitch and 0.7 μm sag. The primary imprint forms the primary structures under conditions of temperature, pressure and timing of approximately 180° C., 40 Bar and 300 seconds. Upon demolding at step 120, a primary pattern 122 including the primary structures is obtained on the PC film. At step 130, a mold 132 for forming the secondary structures on the primary structures by nanoimprinting the secondary structures against the primary imprinted pattern 122 is provided. The mold 132 in accordance with the present embodiment includes conical inverse nanoprotrusion structures having approximate dimensions of 300 nm height and 300 nm pitch. A secondary imprint forms the secondary structures under conditions of temperature, pressure and timing of approximately 155° C., 40 Bar and 540 seconds. Upon demolding at step 140, a final pattern 142 includes the antiretlective hierarchical structures in accordance with the present embodiment.

The composite antiretlective biomimetic hierarchical structures in accordance with the present embodiment are three-dimensional structures that can be fabricated in a controllable means through a sequential nanoimprinting process. Fabricating such structures using conventional photolithography and etching would be difficult and complex. Using the sequential nanoimprinting process 100 also is advantageous because three-dimensional molds are not required to create the three-dimensional structures in patterns 122, 142. The molds 114, 132 may be two-dimensional molds, and through nanoimprint process variations as discussed hereinbelow, the three-dimensional structures in accordance with the present embodiment can be fabricated. This reduces complexity of manufacture of the molds, thereby reducing cost of manufacture and scalability of antireflective film in accordance with the present embodiment.

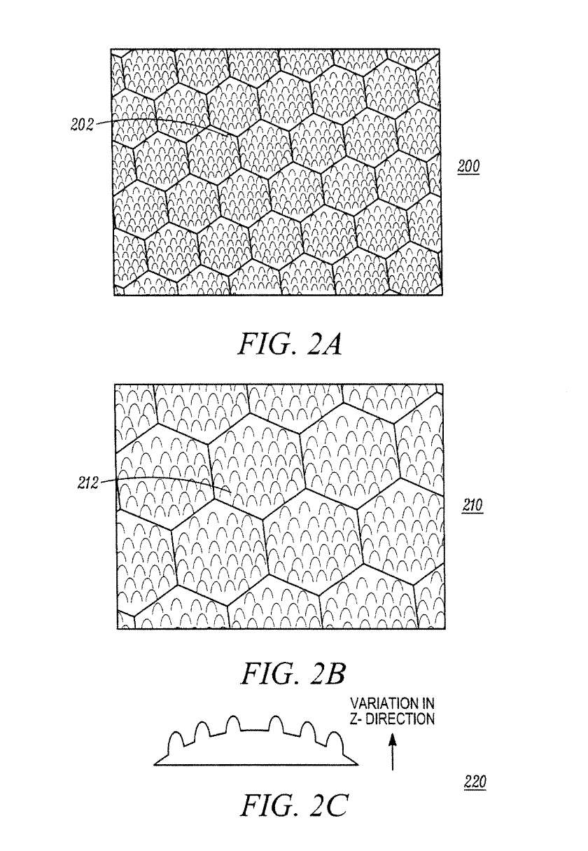

The antireflective hierarchical structures in accordance with the present embodiment include composite antireflective hierarchical structures combining a primary structure and a plurality of secondary structures formed on the primary structure. Referring to FIG. 2, including FIGS. 2A to 2C, the composite antireflective hierarchical structures in accordance with the present embodiment are depicted. FIG. 2A illustrates a top left front perspective view of a cluster of primary structures in accordance with the present embodiment. The pattern depicted in FIG. 2 includes a primary structure of approximately two micrometer diameter hexagonal-packed clusters. After the primary imprint, at step 120 (FIG. 1), the primary pattern 122 includes hexagonal-packed microlens structures of approximately 1.8 μm diameter and 2 μm pitch. Through the specific secondary imprinting conditions by the mold 132, these primary structures are patterned to form 2 μm diameter merged hexagonal-packed clusters 202.

FIG. 2B illustrates a top left front perspective view 210 of a plurality of secondary structures formed on the primary structures in accordance with the present embodiment. A plurality of secondary structures are formed on top of each of the primary structures by nanoimprinting conical nanoprotrusions having approximately 300 nanometer height and 300 nanometer pitch on top of the primary pattern 122 to obtain the final pattern 142 (FIG. 1). FIG. 2C illustrates a cross sectional view 220 of the composite antireflective hierarchical structures in accordance with the present embodiment showing the structural variation in the z-axis direction.

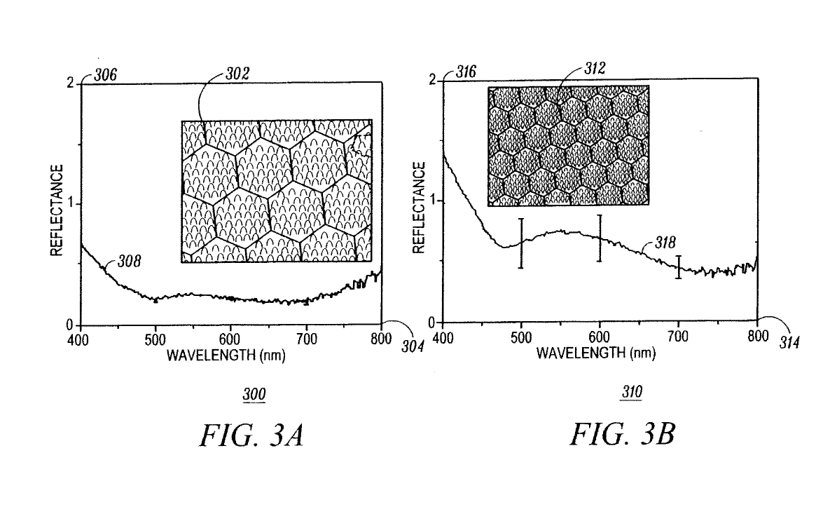

Reflectivity within the visible light spectrum (i.e., across the visible wavelength range of four hundred nanometers to eight hundred nanometers) of fabricated antireflective film including the antireflective biomimetic hierarchical structures in accordance with the present embodiment was measured as compared to a conventional “motheye” structure on a PC film using a dual beam spectrophotometer. FIG. 3, including FIGS. 3A and 3B, illustrates graphs of the reflectivity of the antireflective biomimetic hierarchical structures of FIG. 2 in accordance with the present embodiment as compared to the conventional antireflective “motheye” structures.

Referring to FIG. 3A, a graph 300 illustrates reflectivity of the antireflective biomimetic hierarchical structures in accordance with the present embodiment (depicted in image 302) across the visible light spectrum. The electromagnetic wavelength is plotted along the x-axis 304 and the reflectivity of the antireflective biomimetic hierarchical structures in accordance with the present embodiment is plotted along the y-axis 306. FIG. 3B depicts a graph 310 illustrating reflectivity of the conventional antireflective “motheye” structures (depicted in image 312) across the visible light spectrum, where the electromagnetic wavelength is plotted along the x-axis 314 and the reflectivity of the conventional structures is plotted along the y-axis 316. FIGS. 3A and 3B demonstrate on respective traces 308, 318 that the antireflective biomimetic hierarchical structures 302 of the patterned film 142 yields an improvement in the overall reflectivity as compared to a “motheye” structured PC film, achieving reflectivity in the range of 0.16%˜0.67% while conventional techniques can only achieve reflectivity in the range of 0.36% 1.4%. The images 302 and 312 are scanning electron microscopic images of patterned film 142 in accordance with the present embodiment (image 302) and conventional patterned film (image 312).

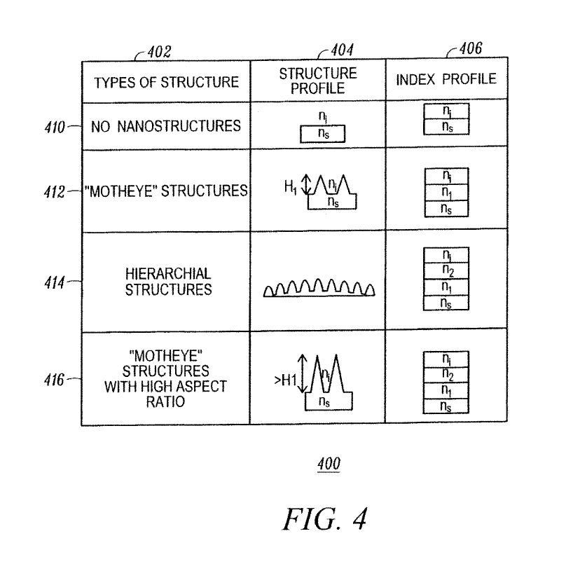

The advantageous reduction in overall reflectivity using the antireflective biomimetic hierarchical structure in accordance with the present embodiment as depicted in FIG. 3 can be mainly attributed to two factors: a gradual change of refractive index profile from the air to the substrate using the novel three-dimensional structure in accordance with the present embodiment, and a synergistic effect of the primary structure (a microlens structure having dimensions in the micrometer range) and the secondary structures (the “motheye” structures having dimensions in the nanometer range). Referring to FIG. 4, a table 400 of different antireflective structures and their corresponding refractive index profile, including the antireflective hierarchical structures in accordance with the present embodiment is depicted. Table 400 lists the types of structures in column 402, depicts the corresponding structure profile in column 404 and corresponding refractive index profile in column 406. Fresnel's Law states that reflection from the substrate surface occurs when there is an abrupt change in the refractive index between the air/substrate interface. This is shown in row 410 where there are no nanostructures. Conventional approaches to reduce this reflection use the “motheye” structures (conical nanoprotrus ons with approximately three hundred nanometers of pitch and height (similar to mold 132 (FIG. 1)) as shown in row 412. These two-dimensional structures reduce reflection by creating a gradual refractive index profile between the air/substrate interfaces. The more gradual the refractive index profile between the air/substrate interfaces, the more effective is the reduction of reflection, since there are no abrupt index changes from air to the substrate.

The antireflective biomimetic composite hierarchical structures in accordance with the present embodiment are three-dimensional structures and the properties of these structures are shown on row 414. The additional variation in the z-direction (see cross sectional view 220 (FIG. 2)) allows a more gradual effective index profile than the conventional two-dimensional “motheye” structures and thus minimizes the reflection further. Other approaches using additional variations in the z-direction to reduce reflectivity is shown in row 416: through the use of higher aspect ratio “motheye” structures, a more gradual effective refractive index may be achieved thereby reducing reflectivity. As discussed previously, currently such structures are not scalable and/or may require complex fabrication techniques.

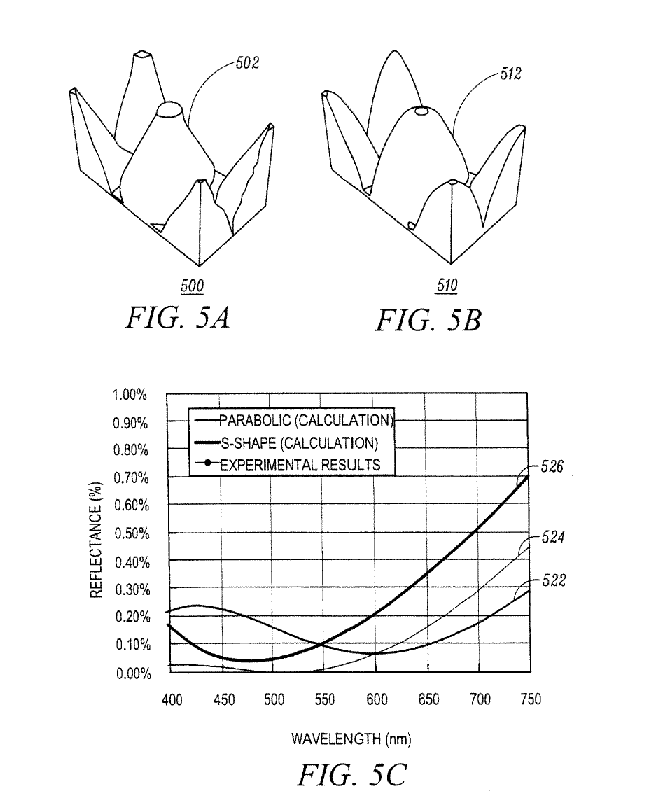

As discussed above, another approach to reduce reflection of antireflective structures uses shape variation of the structures. Reduction in reflection may be achieved using “S” shape structures as compared to parabolic shape structures. FIG. 5, including FIGS. 5A to 5C, illustrates a comparison of “S” shape antireflective structures and parabolic antireflective structures. FIG. 5A illustrates a top left front perspective view 500 of the “S” shape antireflective structures 502. FIG. 5B illustrates a top left front perspective view 510 of the parabolic antireflective structures 512.

FIG. 5C is a graph 520 of calculated reflectivity 522 of the structures of FIG. 5B, calculated reflectivity 524 of the structures of FIG. 5A and experimentally determined reflectivity 526 of the hierarchical structures in accordance with the present embodiment. The hierarchical structures in accordance with the present embodiment can be considered a type of shape variation with its three-dimensional structure. Preferably this three-dimensional structure includes composite antireflective hierarchical structures having primary structures and secondary structures, wherein the secondary structures include conical nanoprotrusions. Thus it can be seen that graph 520 depicts that alterations of shape of antireflective structures adjust a reflectivity spectrum across a desired wavelength range. Those skilled in the art will realize that this is also true for alterations in height. Accordingly, alterations of height and shape of the primary structures and alterations of height and shape of the secondary structures can provide tuning of a reflectivity spectrum across a desired wavelength range.

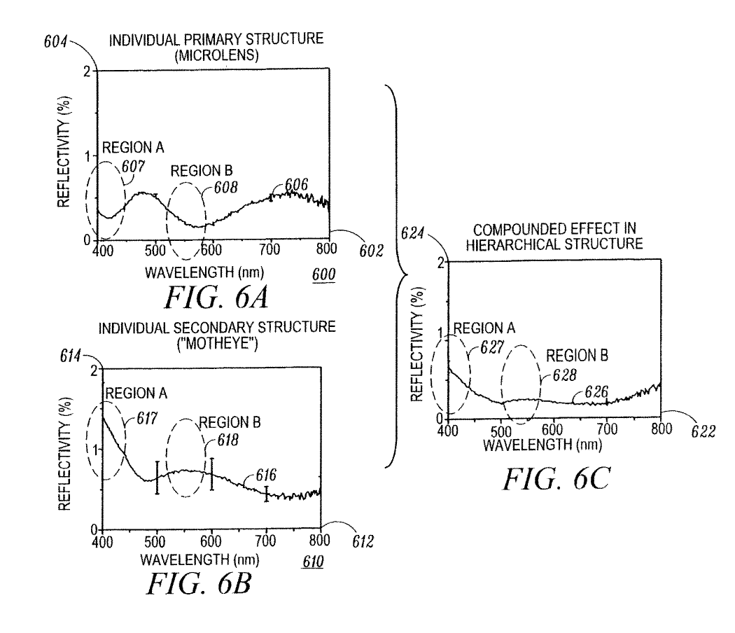

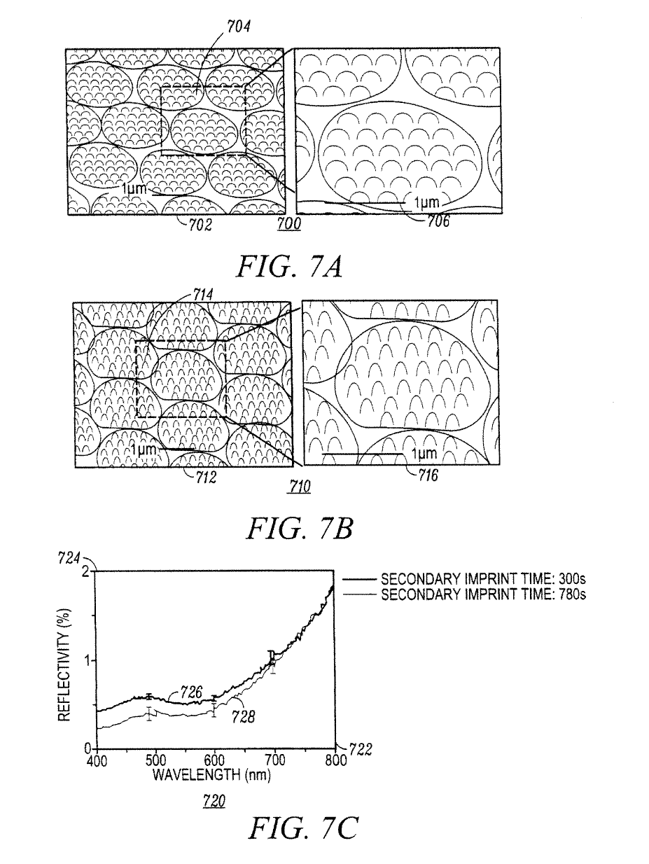

The antireflective biomimetic hierarchical structures in accordance with the present embodiment include primary microlens structures and secondary “motheye” nanostructures. Each primary structure and the plurality of secondary structures formed on each such primary structure interact synergistically to minimize reflectivity. FIG. 6, including FIGS. 6A to 6C, illustrates measured reflectivity of the component structures and the composite structures of the antireflective hierarchical structures in accordance with the present embodiment.

FIG. 6A is a graph 600 of the reflectivity of an individual microlens primary structure of the antireflective hierarchical structures in accordance with the present embodiment, where electromagnetic wavelength is plotted along the x-axis 602 and reflectivity is plotted along the y-axis 604. The trace 606 depicts the measured reflectivity across the visible light spectrum. FIG. 6B is a graph 610 of the reflectivity of an individual “motheye” secondary structure of the antireflective hierarchical structures in accordance with the present embodiment, where electromagnetic wavelength is plotted along the x-axis 612 and reflectivity is plotted along the y-axis 614. The trace 616 depicts the measured reflectivity across the across the visible light spectrum.

FIG. 6C is a graph of the reflectivity of a composite antireflective hierarchical structure in accordance with the present embodiment where electromagnetic wavelength is plotted along the x-axis 612 and reflectivity is plotted along the y-axis 614. Trace 626 depicts the measured reflectivity across the visible light spectrum.

The compounded effect of both the primary structures and the secondary structures of the hierarchical structures in accordance with the present embodiment creates a synergistic reduction in the overall reflectivity. For instance, the high reflectivity (1.5%) seen in the individual “motheye” structure at the short wavelength range of four hundred nanometers (region 617) can be suppressed in the hierarchical structure through the compounded effect with the microlens structure which has a low reflectivity (˜0.4%) (region 607), where the compounded effect can be seen in region 627. Similarly, the reflection peak at five hundred and eighty nanometer of the individual “motheye” structure (region 618) can be minimized in the hierarchical structure through the compounded effect with the microlens structure that has a reflection valley at five hundred and eighty nanometers (region 608) to form the effect at region 628.

Referring to FIG. 7, including FIGS. 7A to 7C, views and reflectivity of antireflective hierarchical structures in accordance with the present embodiment are depicted, including unmerged primary structures in accordance with alternate embodiments. Different types of hierarchical structures in accordance with alternate embodiments can be fabricated using the molds 114, 132 (FIG. 1) through the variation of the secondary imprint process conditions. For example, at a lower secondary imprint temperature of 150° C., and at a fixed pressure of forty bars, it is possible to fabricate a hierarchical structure with an unmerged primary layer structure. Variation of the secondary imprint time (e.g., from 300 s to 780 s) creates a different secondary structure on top of the primary layer. FIG. 7A includes top left front perspective views 700 of composite antireflective hierarchical structures including unmerged primary structures with a secondary structure imprint time of three hundred seconds. The scanning electron microscopy view 702 includes a portion 704 which is further magnified in the view 706. FIG. 7B includes top left front perspective views 710 of composite antireflective hierarchical structures including unmerged primary structures with a secondary structure imprint time of seven hundred and eighty seconds. The scanning electron microscopy view 712 includes a portion 714 which is further magnified in the view 716.

FIG. 7C is a graph 720 of the reflectivity of the composite structures of FIGS. 7A and 7B across the visible light spectrum, where electromagnetic wavelength is plotted along the x-axis 722 and reflectivity is plotted along the y-axis 724. The composite antireflective hierarchical structures of FIGS. 7A and 7B can achieve a low reflectivity (0.25%) at the short wavelength range of four hundred nanometers compared to the conventional “motheye” structures which have reflectivity ˜1.4% at this wavelength. Thus, such composite antiretlective hierarchical structures may be suitable for applications that need low reflectivity in the ultraviolet/blue wavelength region. The traces 726 and 728 depict reflectivity spectrums for imprinted hierarchical structures with unmerged primary layer at secondary imprint times respectively of 300 seconds and 780 seconds.

The use of biomimetic hierarchical structures in accordance with the present and alternate embodiments as described hereinabove provides robust, highly scalable antiretlective film with improved antiretlective properties. Such film can achieve a better reflectivity than film manufactured with conventional “motheye” structures. In fact, a reflectivity of 0.16%˜0.67% over the visible wavelength range from four hundred nanometers to eight hundred nanometers is achieved with hierarchical structures in accordance with the present embodiment, while conventional “motheye” structures are only able to achieve a reflectivity of 0.36%˜1.4% over the visible wavelength range from four hundred nanometers to eight hundred nanometers.

Therefore, antireflective films including composite antireflective biomimetic hierarchical structures in accordance with the present and alternate embodiments described hereinabove can prevent “ghost images”, reduce glare and improve contrasts in display applications. In photovoltaic applications, such films can minimize reflection from the surface of solar cells to increase light collection efficiency thereof. Further, such films can minimize reflection to improve device performance in sensors and optical or photonic devices. The present embodiment and disclosed alternate embodiments can be used directly as an antireflective free-standing film, or it can be envisioned to be applied to the products by directly manufacturing the composite antiretlective biomimetic hierarchical structures in accordance with the present and alternate embodiments thereon.

Thus it can be seen that an antiretlective film that achieves reflectivity less than one percent and is scalable without complex fabrication has been provided. The three-dimensional antiretlective hierarchical structures in accordance with the present and disclosed alternate embodiments offer shape variations and a more gradual refractive index variation of the structures in order to reduce the abrupt refractive index between the air/substrate interfaces. The composite biomimetic antiretlective hierarchical structures in accordance with the preferred embodiment and disclosed alternate embodiments differentiate themselves from the conventional two-dimensional “motheye” antiretlection structures and provide lower reflectivity performance through the synergistic effect of the primary and the secondary layer reflectivity of the hierarchical antireflection structures.

While several exemplary embodiments have been presented in the foregoing detailed description of the invention, it should be appreciated that a vast number of variations exist, including variations as to the structures formed through varying manufacturing parameters or hierarchical structure shapes and sizes. It should further be appreciated that the exemplary embodiments are only examples, and are not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements and method of fabrication described in an exemplary embodiment without departing from the scope of the invention as set forth in the appended claims.

What is claimed is:

1. An antiretlective biomimetic hierarchical structure comprising:
one or more clusters of primary structures, each of the primary structures having dimensions in the micrometer range; and
a plurality of secondary structures formed on each of the primary structures, each of the plurality of secondary structures having dimensions in the nanometer range.

2. The antiretlective biomimetic hierarchical structure in accordance with claim 1 wherein each of the primary structures has a major dimension of approximately two micrometers.

3. The antireflective biomimetic hierarchical structure in accordance with claim 1 wherein each of the plurality of secondary structures has dimensions of approximately three hundred nanometers in pitch and height.

4. The antireflective biomimetic hierarchical structure in accordance with claim 1 wherein the primary structures and the plurality of secondary structures incorporate shape variations and gradual refractive index variations to reduce an abrupt refractive index at air/substrate interfaces for minimizing reflection within a visible light spectrum.

5. The antireflective biomimetic hierarchical structure in accordance with claim 4 wherein the one or more clusters of primary structures comprise a pattern of approximately two diameter hexagonal-packed clusters.

6. The antireflective biomimetic hierarchical structure in accordance with claim 4 wherein the plurality of secondary structures comprise a pattern comprising conical nanoprotrusions having dimensions of approximately three hundred nanometers in pitch and height.

7. The antireflective biomimetic hierarchical structure in accordance with claim 1 wherein reflective properties of the primary structures and the plurality of secondary structures interact synergistically to minimize reflectivity.

8. The antireflective biomimetic hierarchical structure in accordance with claim 7 wherein the one or more clusters of primary structures comprise a pattern of approximately two diameter hexagonal-packed clusters.

9. The antireflective biomimetic hierarchical structure in accordance with claim 7 wherein the plurality of secondary structures comprise a pattern comprising conical nanoprotrusions having dimensions of approximately three hundred nanometers in pitch and height.

10. The antireflective biomimetic hierarchical structure in accordance with claim 1 wherein alterations of height and shape of the primary structures and alterations of height and shape of the plurality of secondary structures can provide tuning of a reflectivity spectrum across a desired wavelength range.

11. The antireflective biomimetic hierarchical structure in accordance with claim 1 wherein the primary structures and the plurality of secondary structures are fabricated using a sequential nanoimprint process which varies fabrication parameters for sequences of the sequential nanoimprint process, wherein the fabrication parameters are selected from a group of process parameters including temperature, pressure and time.

12. The antireflective biomimetic hierarchical structure in accordance with claim 11 wherein the clusters of the primary structures are fabricated under process parameters of 180° C. at forty bars of pressure for three hundred seconds, and wherein the plurality of secondary structures are thereafter sequentially fabricated as merged hierarchical structures on the clusters of the primary structures under process parameters of 155° C. at forty bars of pressure for five hundred and forty seconds.

13. The antireflective biomimetic hierarchical structure in accordance with claim 11 wherein the clusters of the primary structures are fabricated under process parameters of 180° C. at forty bars of pressure for three hundred seconds, and wherein the plurality of secondary structures are thereafter sequentially fabricated on the clusters of the primary structures under process parameters of 150° C. at forty bars of pressure for a time varying from three hundred seconds to seven hundred and eighty seconds as unmerged hierarchical structures of different types.

14. The antireflective biomimetic hierarchical structure in accordance with claim 1 further comprising additional hierarchical structures fabricated through additional sequential nanoimprinting process steps.

15. A composite antireflective hierarchical structure comprising:
a primary structure having a major dimension of approximately two micrometers; and
one or more secondary structures formed on the primary structure, each of the one or more secondary structures having dimensions of approximately three hundred nanometers in pitch and height.

16. The composite antiretlective hierarchical structure in accordance with claim 15 wherein the primary structure has a hexagonal shape.

17. The composite antireflective hierarchical structure in accordance with claim 15 wherein each of the one or more secondary structures has a conical shape.

18. An antireflective film comprising:
a film; and
a pattern of antireflective biomimetic hierarchical structures formed on the film, each of the antireflective biomimetic hierarchical structures comprising:
a primary structure having a major dimension of approximately two micrometers; and
one or more secondary structures formed on the primary structure, each of the one or more secondary structures having dimensions of approximately three hundred nanometers in pitch and height.

19. The antiretlective surface in accordance with claim 18 wherein the film comprises a polycarbonate film.

20. The antireflective surface in accordance with claim 18 wherein the primary structure has a hexagonal shape, and wherein each of the one or more secondary structures has a conical shape.
